(19) United States
(12) Patent Application Publication
(10) Pub. No.: US 2003/0202675 A1
(43) Pub. Date: Oct. 30, 2003

(54) Speaker apparatus

(75) Inventor: Masanori Ito, Tendo (JP)

Correspondence Address: SUGHRUE MION, PLLC, 2100 PENNSYLVANIA AVENUE, N.W., WASHINGTON, DC, 20037, US

(73) Assignee: PIONEER CORPORATION TOHOKU PIONEER CORPORATION

(21) Appl. No.: 10/410,441

(22) Filed: Apr. 10, 2003

(30) Foreign Application Priority Data
Apr. 30, 2002 (JP) 2002-129055

(51) Int. Cl. H04R 1/00; H04R 9/06; H04R 11/02

(52) U.S. Cl. 381/398; 381/430; 381/433

(57) ABSTRACT

A speaker apparatus is provided. A frame has a projecting portion projecting toward a diaphragm at the periphery of the frame. The diaphragm has a rising portion extending opposite to the frame from the periphery of the diaphragm and having an outside surface along an inside surface of the frame projecting portion. The outside surface of the rising portion is adhered to the inside surface of the frame projecting portion.

### BACKGROUND OF THE INVENTION

1. Field of the Invention

The present invention relates generally to a speaker apparatus and, more particularly, to a speaker apparatus wherein a periphery of a diaphragm is supported by a frame.

2. Description of the Related Art

A dome-speaker shown in FIGS. 7A,7B is conventionally suggested as an example of the above speaker apparatus. FIG. 7A is an exploded half-sectional view showing a prior art dome-speaker. FIG. 7B is a half-sectional view showing the prior art dome-speaker of FIG. 7A.

In this dome-speaker, a circular pole plate 10, a magnet 11, and a yoke 12 constitute a magnetic circuit having a ring-like magnetic gap 13. The magnetic gap 13 is formed between a side surface of the pole plate 10 and an inner surface of the yoke 12. A frame 14 of resin is formed around the yoke 12. The magnetic circuit and the frame constitute an frame assembly.

A diaphragm 15 is arranged over the frame assembly. The diaphragm 15 is in a circular or elliptic shape. The diaphragm 15 has a vibrating portion 16 having a dome shape, a recess (or a groove) 17 provided along the peripheral edge of the vibrating portion 16, an edge damper 18a provided along the peripheral edge of the recess 17, and an edge damper frame 18b provided along the peripheral edge of the edge damper 18a. The edge damper frame 18b is provided along a horizontal support plane 14b of the frame 14.

The diaphragm 15 is provided with a rising portion 18c which vertically stands from the peripheral edge of the edge damper frame 18b. The rising portion 18c is provided along an inside surface 14a-1 of a projecting portion 14a formed outside the horizontal support plane 14b of the frame 14. The diaphragm 15 is provided with an engaging portion 18d formed from the top of the rising portion 18c. The engaging portion 18d is a plane parallel to a radial direction of the diaphragm 15. The engaging portion 18d engages an inside surface 14a-2 of the projecting portion 14a.

The edge damper 18a, the edge damper frame 18b, the rising portion 18c and the engaging portion 18d constitute an edge portion 18. The vibrating portion 16, the recess 17 and the edge portion 18 are integrally formed of a single resin film and constitute the diaphragm 15.

The diaphragm 15 is arranged such that the rising portion 18c abuts the inside surface 14a-1 of the projecting portion 14a of the frame 14. The diaphragm 15 is attached to the frame assembly such that the center of the diaphragm 15 aligns with the center of the frame assembly. Positioning of the diaphragm 15 in a radial direction thereof with respect to the frame 14 can be done by the rising portion 18c.

When the above edge damper frame 18b is arranged on the horizontal support plane 14b provided of the frame 14, the recess 17 is arranged in the magnetic gap 13. Positioning of the diaphragm 15 in an axial direction thereof with respect to the frame 14 can be done by the edge damper frame 18b.

As above, the recess 17 can be properly arranged in the magnetic gap 13 of the magnetic circuit. A voice coil 19, which is formed by winding an electric wire, is adhered to the recess 17. The voice coil 19 is elastically supported by the edge damper 18a in the magnetic gap 13 along with the recess 17.

In the above speaker apparatus, the diaphragm 15 is attached to the frame 14 by adhering the edge damper frame 18b of the diaphragm 15 to the horizontal support plane 14b of the frame 14 with an adhesive. A frame cover 20 to protect the diaphragm 15 is provided over the diaphragm 15.

Generally, a speaker apparatus with a larger vibration area can generate a lager sound volume at a low frequency band (i.e. the lower register) due to a larger mass of the diaphragm and accordingly due to a lower minimum resonance frequency. And also, a speaker apparatus with a larger vibration area can generate a lager sound volume at a low frequency band due to a higher radiation impedance and due to a higher-sensitivity sound pressure characteristic.

With respect to the above prior art dome-speaker, however, the diaphragm 15 is attached to the frame 14 by adhering the edge damper frame 18b of the diaphragm 15 to the horizontal support plane 14b of the frame 14 with an adhesive. An adherence area needs to be larger for enhancing the strength of adherence.

That is, the width of the horizontal support plane 14b and that of the edge damper frame 18b need to be large for obtaining a sufficient adherence strength. In this case, the diameter of the vibrating portion 16 and that of the edge damper 18a become small. That is, the vibration area becomes small.

### SUMMARY OF THE INVENTION

In view of the foregoing, an object of the present invention is to provide a speaker apparatus wherein a playback at low frequencies is possible by making a minimum resonance frequency small by enlarging a vibration area and the sound pressure sensitivity is large.

In order to achieve the above object, as a first aspect of the present invention, a speaker apparatus comprises: a diaphragm; a frame arranged under the diaphragm and supporting a periphery of the diaphragm, wherein the frame has, at a periphery thereof, a frame projecting portion extending toward the diaphragm, the diaphragm has a rising portion extending opposite to the frame from the periphery of the diaphragm and having an outside surface along an inside surface of the frame projecting portion, and the outside surface of the rising portion is adhered to the inside surface of the frame projecting portion.

As a second aspect of the present invention, a speaker apparatus comprises: a diaphragm; a frame arranged under the diaphragm and supporting a periphery of the diaphragm, wherein the frame has, at a periphery thereof, a frame projecting portion extending toward the diaphragm, the diaphragm has a falling portion extending toward the frame from the periphery of the diaphragm and having an inside surface along an outside surface of the frame projecting portion, and the inside surface of the falling portion is adhered to the outside surface of the frame projecting portion.

As a third aspect of the present invention, based on the first aspect, the inside surface of the frame projecting portion is perpendicular to a radial direction of the diaphragm.

As a fourth aspect of the present invention, based on the second aspect, the outside surface of the frame projecting portion is perpendicular to a radial direction of the diaphragm.

As a fifth aspect of the present invention, based on the first aspect, the inside surface of the frame projecting portion is inclined about a bottom end of the inside surface outwardly with respect to an axial direction of the diaphragm.

As a sixth aspect of the present invention, based on the second aspect, the outside surface of the frame projecting portion is inclined about a bottom end of the outside surface inwardly with respect to an axial direction of the diaphragm.

As a seventh aspect of the present invention, based on the fifth aspect, an angle of inclination of the inside surface of the frame with respect to the axial direction is not more than 45 degrees.

As an eighth aspect of the present invention, based on the sixth aspect, an angle of inclination of the outside surface of the frame with respect to the axial direction is not more than 45 degrees.

According to the above-described structures of the present invention, the following advantages are provided.

(1) Because the outside surface of the rising portion of the diaphragm is adhered to the inside surface of the frame projecting portion of the frame, a horizontal portion, of the diaphragm, for adherence can be eliminated, thereby enlarging a vibration area. Therefore, a playback at low frequencies is possible by making a minimum resonance frequency small, and the sound pressure sensitivity can be large.

(2) Because the inside surface of the falling portion of the diaphragm is adhered to the outside surface of the frame projecting portion of the frame, a horizontal portion, of the diaphragm, for adherence can be eliminated, thereby enlarging a vibration area. Besides, because a projecting portion is not necessary outside an outside surface of the falling portion, the vibration area can be further enlarged. Therefore, a playback at low frequencies is possible by making a minimum resonance frequency small, and the sound pressure sensitivity can be large.

(3) Because the inside surface of the frame projecting portion is provided in a manner perpendicular to the radial direction of the diaphragm, a horizontal portion, of the diaphragm, for adherence can be eliminated, thereby enlarging a vibration area. Therefore, a playback at low frequencies is possible by making a minimum resonance frequency small, and the sound pressure sensitivity can be large.

(4) Because the outside surface of the frame projecting portion is provided in a manner perpendicular to the radial direction of the diaphragm, a horizontal portion, of the diaphragm, for adherence can be eliminated, thereby enlarging a vibration area. Therefore, a playback at low frequencies is possible by making a minimum resonance frequency small, and the sound pressure sensitivity can be large.

(5) When the outside surface of the rising portion is adhered to the inside surface of the frame projecting portion with an adhesive, the adhesive can be prevented from dripping because the inside surface of the frame projecting portion is inclined.

(6) When the inside surface of the falling portion is adhered to the outside surface of the frame projecting portion with an adhesive, the adhesive can be prevented from dripping because the outside surface of the frame projecting portion is inclined.

(7) The frame and the horizontal plane each are provided with the horizontal plane so as to vertically position the diaphragm with respect to the frame. When the angle of inclination of the inside surface of the frame are not more than 45 degrees, the vibration area can be large.

(8) The frame and the horizontal plane each are provided with the horizontal plane so as to vertically position the diaphragm with respect to the frame. When the angle of inclination of the outside surface of the frame are not more than 45 degrees, the vibration area can be large.

The above and other objects and features of the present invention will become more apparent from the following description taken in conjunction with the accompanying drawings.

### BRIEF DESCRIPTION OF THE DRAWINGS

FIG. 1 is a half-sectional view showing the first embodiment of the inventive speaker apparatus.

FIG. 2 is a half-sectional view showing the second embodiment of the inventive speaker apparatus.

FIG. 3 is a half-sectional view showing the third embodiment of the inventive speaker apparatus.

FIG. 4 is a half-sectional view showing the fourth embodiment of the inventive speaker apparatus.

FIG. 5 is a half-sectional view showing the fifth embodiment of the inventive speaker apparatus.

FIGS. 6A,6B,6C are partly enlarged sectional views showing the sixth embodiment of the inventive speaker apparatus.

FIG. 7A is an exploded half-sectional view showing a prior art speaker apparatus.

FIG. 7B is a half-sectional view showing the prior art speaker apparatus of FIG. 7A.

### DESCRIPTION OF THE PREFERRED EMBODIMENT(S)

Embodiment(s) of the present invention will now be described in further detail with reference to the accompanying drawings.

FIG. 1 is a half-sectional view showing the first embodiment of the inventive speaker apparatus.

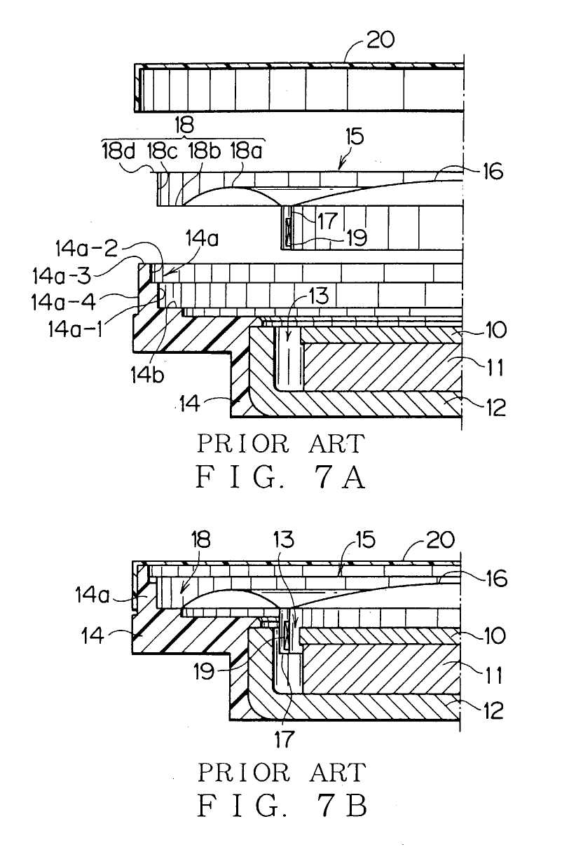

An adhering portion of a frame 14 and a diaphragm 15 of the present invention differs from that of the prior art speaker apparatus shown in FIG. 7. In the prior art speaker apparatus, the horizontal support plane 14b of the frame 14 and the edge damper frame 18b of the diaphragm 15 are adhered to each other with an adhesive. However, in the present invention, a rising portion 18c of the diaphragm 15 is adheres to an inside surface 14a-1 of a frame projecting portion 14a with an adhesive. That is, the surfaces both perpendicular to the radial direction are adhered to each other.

As above, because the surfaces both perpendicular to the radial direction are adhered to each other, a horizontal support plane 14b only needs to have an area enough to axially position the diaphragm. Therefore, the horizontal support plane 14b can be small, thereby enlarging a vibration area. Therefore, a playback at low frequencies is possible by making a minimum resonance frequency small, and the sound pressure sensitivity can be large.

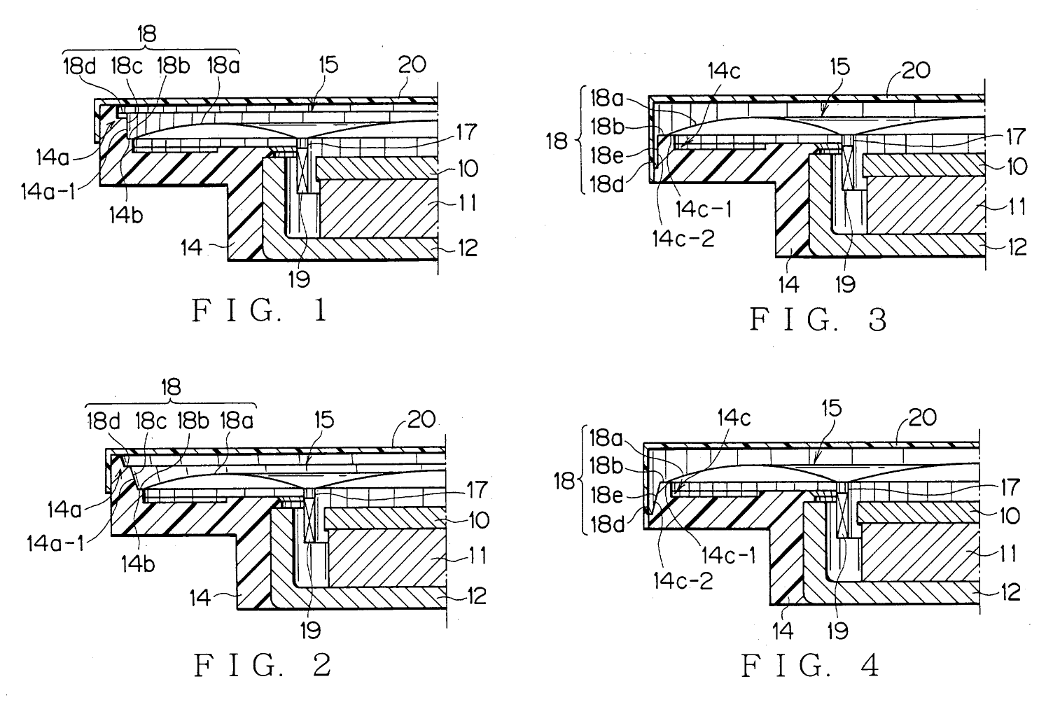

In the first embodiment, the inside surface 14a-1 of the frame projecting portion 14a is perpendicular to the radial direction. Therefore, when an adhesive is applied to the inside surface 14a-1 of the projecting portion 14a, the adhesive is likely to drip in a vertical direction. In the second embodiment, as shown in FIG. 2, the inside surface 14a-1 is inclined outward about the lower end thereof so as to prevent the adhesive from dripping. When the inclination angle is not more than 45 degrees, the vibration area can be securely large even if the horizontal support plane 14b and the edge damper frame 18b are considered. The horizontal support plane 14b and the edge damper frame 18b are necessary for positioning the diaphragm 15 in a vertical direction (i.e. the axial direction of the speaker apparatus).

Next, the third embodiment is described with reference to FIG. 3. In the third embodiment, the shape of the frame 14 is different from those of the previous embodiments. In the first and the second embodiments, each frame 14 has the projecting portion 14a arranged outside the diaphragm 15. In the third embodiment, the frame 14 has a projecting portion 14c arranged inside the diaphragm 15. A horizontal support plane 14c-1 to support the edge damper frame 18b and to vertically position the diaphragm 15 with respect to the frame 14 is formed on the top of the projecting portion 14c.

The shape of the edge portion 18 of the diaphragm 15 is also different from those of the first and the second embodiments. In the first and the second embodiments, the edge portion 18 has the rising portion 18c standing toward the frame cover 20 from the peripheral edge of the edge damper frame 18b.

The edge portion 18 of the third embodiment has a falling portion 18e falling vertically from the peripheral edge of the edge damper frame 18b. The falling portion 18e is provided along an outside surface 14c-2 of the projecting portion 14c. An inside surface of the falling portion 18e is adhered to the outside surface 14c-2 of the projecting portion 14c with an adhesive.

An engaging portion 18d is provided on a bottom end portion of the falling portion 18e. The engaging portion 18d abuts the inside surface of the frame cover 20.

In the third embodiment, similarly to the first and the second embodiments, because the surfaces both perpendicular to the radial direction are adhered to each other, the horizontal support plane 14c-1 and the edge damper frame 18b only need to have respective areas enough to axially position the diaphragm 15. Therefore, the horizontal support plane 14c-1 and the edge damper frame 18b can be small, thereby enlarging a vibration area. Therefore, a playback at low frequencies is possible by making a minimum resonance frequency small, and the sound pressure sensitivity can be large.

In the third embodiment, the falling portion 18e of the diaphragm 15 extends along the outside surface 14c-2 of the projecting portion 14c from the edge damper frame 18b. Therefore, a projecting portion is not necessary outside an outside surface of the falling portion 18e.

Therefore, the vibration area including the vibrating portion 16 and the edge damper 18a can be larger. Therefore, a playback at low frequencies is possible by making a minimum resonance frequency small, and the sound pressure sensitivity can be large.

In the third embodiment, the outside surface 14c-2 of the projecting portion 14c is perpendicular to the radial direction. Therefore, when an adhesive is applied to the outside surface 14c-2 of the projecting portion 14c, the adhesive is likely to drip in a vertical direction. In the fourth embodiment, as shown in FIG. 4, the outside surface 14c-2 is inclined inward about the lower end thereof so as to prevent the adhesive from dripping. When the inclination angle is not more than 45 degrees, the vibration area can be securely large even if the horizontal support plane 14c-1 and the edge damper frame 18b are considered.

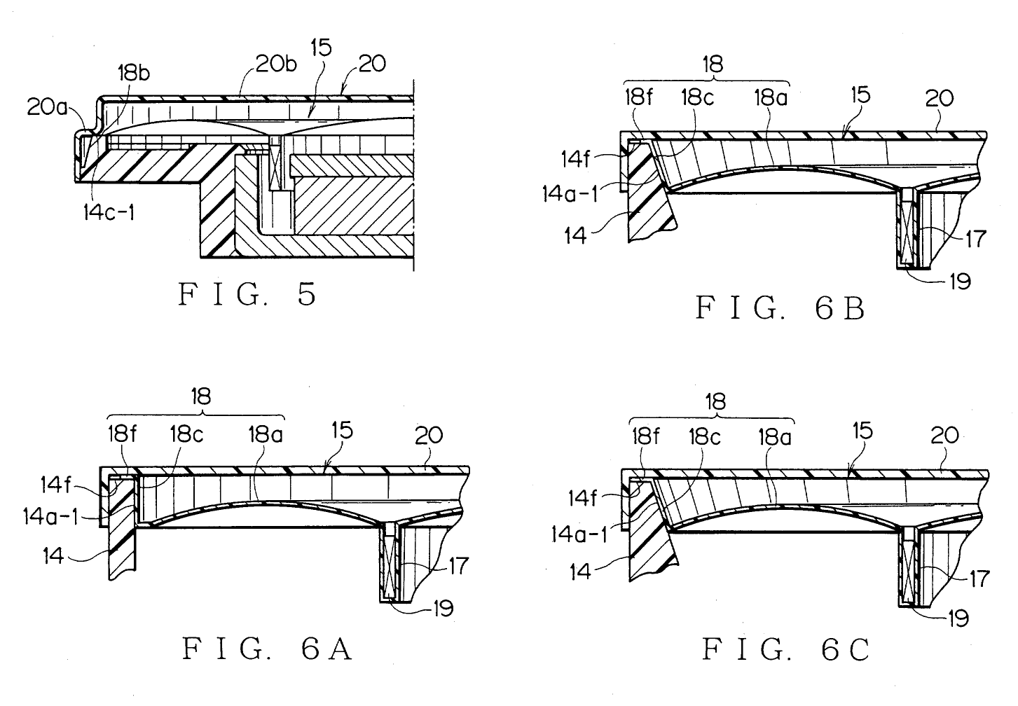

In the third and the fourth embodiments, there is not a portion positioning a frame cover 20 in a vertical direction. In the fifth embodiment, as shown in FIG. 5, the frame cover 20 has a peripheral surface 20a and an inside plane 20b. The peripheral surface 20a as well as the edge damper frame 18b of the diaphragm 15 is supported by the horizontal support plane 14c-1.

In the first and the second embodiments, the diaphragm 15 is vertically positioned with respect to the frame 14 by means of the edge damper frame 18b provided on the peripheral edge of the edge damper 18a. In the sixth embodiment, as shown in FIGS. 6A,6B, the diaphragm 15 is provided with a collar portion 18f continuing from the rising portion 18c along a horizontal plane 14f continuing from the inside surface 14a-1 of the frame 14. The diaphragm 15 is vertically positioned by the collar portion 18f.

Referring to FIGS. 6A,6B, the collar portion 18f does not extend until an inside surface of the frame cover 20. As shown in FIG. 6C, the collar portion 18f may be extended until the inside surface of the frame cover 20.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein. Incidentally, the contents of Japanese Patent Application No. 2002-129055 is hereby incorporated by reference.

What is claimed is:

1. A speaker apparatus, comprising:
a diaphragm;
a frame arranged under the diaphragm and supporting a periphery of the diaphragm,
wherein the frame has, at a periphery thereof, a frame projecting portion extending toward the diaphragm,
the diaphragm has a rising portion extending opposite to the frame from the periphery of the diaphragm and having an outside surface along an inside surface of the frame projecting portion, and
the outside surface of the rising portion is adhered to the inside surface of the frame projecting portion.

2. A speaker apparatus, comprising:
a diaphragm;
a frame arranged under the diaphragm and supporting a periphery of the diaphragm,
wherein the frame has, at a periphery thereof, a frame projecting portion extending toward the diaphragm,
the diaphragm has a falling portion extending toward the frame from the periphery of the diaphragm and having an inside surface along an outside surface of the frame projecting portion, and
the inside surface of the falling portion is adhered to the outside surface of the frame projecting portion.

3. The speaker apparatus as set forth in claim 1, wherein
the inside surface of the frame projecting portion is perpendicular to a radial direction of the diaphragm.

4. The speaker apparatus as set forth in claim 2, wherein
the outside surface of the frame projecting portion is perpendicular to a radial direction of the diaphragm.

5. The speaker apparatus as set forth in claim 1, wherein
the inside surface of the frame projecting portion is inclined about a bottom end of the inside surface outwardly with respect to an axial direction of the diaphragm.

6. The speaker apparatus as set forth in claim 2, wherein
the outside surface of the frame projecting portion is inclined about a bottom end of the outside surface inwardly with respect to an axial direction of the diaphragm.

7. The speaker apparatus as set forth in claim 5, wherein
an angle of inclination of the inside surface of the frame with respect to the axial direction is not more than 45 degrees.

8. The speaker apparatus as set forth in claim 6, wherein
an angle of inclination of the outside surface of the frame with respect to the axial direction is not more than 45 degrees.
